(19) United States
(12) Patent Application Publication
(10) Pub. No.: US 2022/0272795 A1
(43) Pub. Date: Aug. 25, 2022

(54) TRANSPARENT ELECTRODE AND PREPARING METHOD OF TRANSPARENT HEATING FILM COMPRISING THE SAME

(71) Applicants: RESEARCH & BUSINESS FOUNDATION SUNGKYUNKWAN UNIVERSITY, Suwon-si (KR); BKChem Co., Ltd., Suwon-si (KR)

(72) Inventors: Byungkwon LIM, Seoul (KR); Hwiso LEE, Suwon-si (KR)

(73) Assignees: RESEARCH & BUSINESS FOUNDATION SUNGKYUNKWAN UNIVERSITY, Suwon-si (KR); BKChem Co., Ltd., Suwon-si (KR)

(21) Appl. No.: 17/667,004

(22) Filed: Feb. 8, 2022

(30) Foreign Application Priority Data
Feb. 19, 2021 (KR) 10-2021-0022278
Feb. 3, 2022 (KR) 10-2022-0013968

(51) Int. Cl. H05B 3/03; H05B 3/86; H05B 3/28; H05B 3/12

(52) U.S. Cl. CPC H05B 3/03; H05B 3/86; H05B 3/286; H05B 3/12; H05B 2203/013; H05B 2203/017; H05B 2214/04

(57) ABSTRACT

The present application relates to a method for preparing a transparent electrode, the method including a step of forming a thin film by coating a solution containing metal nanowires on a substrate, in which the solution containing the metal nanowires contains a mixed solvent in which a first solvent and a second solvent are mixed, and the first solvent and the second solvent have different surface energies.

### FIELD

The present application relates to a method for preparing a transparent electrode, a method for manufacturing a transparent heating film including a transparent electrode prepared thereby, and a transparent heating film including the transparent electrode prepared thereby.

### DESCRIPTION OF THE RELATED ART

Oxides such as indium tin oxide (ITO), metal thin films, and conductive meshes have been mainly used as materials for existing transparent electrodes since they guarantee high transparency and electrical conductivity. It can be seen that the above materials are commonly used in displays of electronic devices, solar panels, transparent planar heating elements, etc., where transparency and electrical conductivity greatly affect product performance, and the above materials are being used more broadly as materials in which fine patterns are formed through a subsequent process such as a photolithography process or the like. However, since brittle fracture occurs during tensile so that the above materials cannot be used when tension is required during the process or during product use, they cannot be applied to flexible displays, strain sensors, etc., which are expected as next-generation technology application fields, and there is a limit in flexibility in responding to changes in the consumer market's various needs, including changes in the form factor of electronic devices. Therefore, it is necessary to introduce a new material to replace it.

Metal nanowires are attracting attention as a new material capable of replacing the above-mentioned conventional materials. Since metal nanowires are easy to mass-produce in solution so that the production cost can be lowered, and have excellent mechanical properties that change flexibly according to the deformation of the substrate when bent or stretched, a lot of research is being conducted on the metal nanowires as a material for transparent flexible electrodes. Among them, particularly the silver nanowire network is known as a promising electrode material based on its high transparency, electrical conductivity, and flexibility. However, there is a problem in that the silver nanowire network has a high haze, which is one of the elements that impair visibility, and in order to further increase the electrical conductivity, the silver nanowire layer is formed thick or dense so that there is a disadvantage in that the light transmittance is lowered. Accordingly, there have been attempts to form a pattern on the silver nanowire network through a subsequent additional process or a printing process, but there is a disadvantage in that the method of forming patterns through the exposure process and etching causes loss of the silver nanowire and additionally requires the pre- or post-treatment process, and the method of forming printing-based patterns has a disadvantage in that it is difficult to implement a fine line width so that it is not suitable for preparing a transparent electrode having high performance.

Therefore, a method that is simultaneously an economical method with no loss of nanowire material in the manufacturing process and is capable of manufacturing it to have excellent mechanical and optical properties (transparency, haze) is required.

Korean Patent Publication No. 10-2097861, which is the background technology of the present application, relates to a transparent heating film and a manufacturing method thereof. In the above patent, in order to manufacture a transparent heating film with excellent light transmittance, heat dissipation, and exothermic characteristics, a transparent heating film is manufactured by spray coating a mixed solution in which a graphene oxide solution and silver nanowires are mixed, but there is a difference between this and the manufacturing method of the present application.

### CONTENT OF THE INVENTION

### Problem to be Solved

The present application is to solve the above-described problems of the conventional art, an object of the present application is to provide a method for preparing a transparent electrode having excellent properties in which transmittance is improved and haze and sheet resistance are reduced.

Further, another object of the present application is to provide a method for manufacturing a transparent heating film, including a step of preparing a transparent electrode according to the method for preparing a transparent electrode.

Further, another object of the present application is to provide a transparent heating film including a transparent electrode prepared according to the method for preparing a transparent electrode.

However, the technical tasks to be achieved by the embodiment of the present application are not limited to the technical tasks as described above, and other technical tasks may exist.

### Problem Solving Means

As a technical means for achieving the above-described technical tasks, a first aspect of the present application relates to a method for preparing a transparent electrode, including a step of forming a thin film by coating a solution containing metal nanowires on a substrate, in which the solution containing the metal nanowires contains a mixed solvent in which two or more types of solvents are mixed, and the respective solvents in the mixed solvent have different surface energies and boiling points.

According to an embodiment of the present application, the step of forming a thin film by coating a solution containing metal nanowires on the substrate may be performed by a method selected from the group consisting of bar coating, slot die coating, blade coating, and combinations thereof, but the present application is not limited thereto.

According to an embodiment of the present application, the mixed solvent may include a first solvent and a second solvent, and the first solvent and the second solvent may be mixed at a ratio of 1:1 to 1:3, but the present application is not limited thereto.

According to an embodiment of the present application, the first solvent may be water (deionized water), and the second solvent may be one selected from the group consisting of isopropyl alcohol, ethanol, propanol, acetic anhydride, cyclopentanone, diethylhydroxylamine, ethyl acetate, dichloromethane, tert-butyl alcohol, tert-butyl amine, acetonitrile, pyrrolidine, and combinations thereof, but the present application is not limited thereto.

According to an embodiment of the present application, the metal nanowires may have a wave pattern shape and form a network on the transparent electrode, but the present application is not limited thereto.

According to an embodiment of the present application, the metal nanowires may include a metal selected from the group consisting of Ag, Au, Pt, Ti, Pd, Fe, Cu, Co, Ni, Al, and combinations thereof, but the present application is not limited thereto.

According to an embodiment of the present application, the substrate may include a substrate selected from the group consisting of polyimide (PI), polyethylene naphthalate (PEN), polyethylene terephthalate (PET), glass, Si wafer, and combinations thereof, but the present application is not limited thereto.

Further, a second aspect of the present application relates to a method for manufacturing a transparent heating film, including the steps of: preparing a transparent electrode according to the first aspect of the present application; and transferring the transparent electrode onto a first transparent substrate.

According to an embodiment of the present application, the method may further include a step of disposing a second transparent substrate on the transferred transparent electrode, but the present application is not limited thereto.

According to an embodiment of the present application, the step of transferring the transparent electrode onto the first transparent substrate may be performed by a method selected from the group consisting of lamination, thermocompression bonding, mechanical transfer, wet transfer, and combinations thereof, but the present application is not limited thereto.

According to an embodiment of the present application, the first transparent substrate and the second transparent substrate may include one selected from the group consisting of polyvinyl butyral (PVB), glass, ITO, FTO, polyphthalate carbonate (PPC), poly(methyl methacrylate) (PMMA), polyurethane (PU), poly(cyclohexylene dimethylene) terephthalate (PCT), and combinations thereof, but the present application is not limited thereto.

Further, a third aspect of the present application provides a transparent heating film including a first transparent substrate and a second transparent substrate, and including a transparent electrode disposed between the first transparent substrate and the second transparent substrate, in which the transparent electrode is prepared according to the first aspect of the present application.

According to an embodiment of the present application, the transparent electrode may have an electrode formed thereon, but the present application is not limited thereto.

According to an embodiment of the present application, the transparent electrode may have a sheet resistance of 0.1 to 20Ω/□, but the present application is not limited thereto.

The above-described problem solving means is merely exemplary, and should not be construed as an intention of limiting the present application. In addition to the above-described exemplary embodiments, additional embodiments may exist in the drawings and detailed description of the invention.

### Effects of the Invention

The method for preparing a transparent electrode according to the present application may coat a silver nanowire thin film by forming a collective pattern only by a solution coating process, and may form a more improved patterned electrode by controlling the surface properties of the substrate. Through this, optical properties and electrical properties may be improved by having improved transmittance, reduced haze, and reduced sheet resistance values compared to the conventional silver nanowire random network electrode.

Specifically, the transparent electrode forms a wavy pattern structure of silver nanowires so that a lot of empty spaces are included compared to conventional silver nanowire electrodes to have high light transmittance and low haze, it has a low sheet resistance compared to the conventional silver nanowire random network electrode so that it may have comprehensively very excellent transparent electrode properties, and these excellent transparent electrode properties may have high utilization in transparent electrodes and the like of transparent planar heating elements, smart windows, and large-area touch panels in the future. Further, the wavy pattern structure may easily disperse mechanical stress to more stably maintain electrical properties against various mechanical deformations such as bending, twisting, tension, etc. so that it may be applied to various foldable, rollable, stretchable, and wearable devices.

Further, since the method for preparing a transparent electrode according to the present application induces self-pattern formation of silver nanowires through control of the evaporation of a solvent after solution coating so that additional processes such as exposure, etching, and the like, which have been used in conventional silver nanowire patterning, are not used, the process steps may be drastically reduced. Accordingly, since there is no silver nanowire discarded in the etching process after coating, it may be economical.

Further, unlike the conventional transparent heating film in which the thermal stability of silver nanowires was low, and there has been a problem in that the electrode properties could not be maintained due to the occurrence of breakage phenomenon at high temperatures, the transparent heating film manufactured by the manufacturing method according to the present application includes a transparent electrode in which silver nanowires form a wave pattern, and the wave pattern is formed in the form of a bundled mesh that is thicker than general silver nanowires so that it has excellent thermal stability to enable the electrode properties to be maintained even at high temperatures.

However, the effects obtainable in the present application are not limited to the effects as described above, and other effects may exist.

### BRIEF DESCRIPTION OF THE DRAWINGS

FIG. 1 shows optical microscope (OM) images of the silver nanowire thin film manufactured with a solution containing silver nanowires containing solvents having various mixing ratios according to Example 1 of the present application;

FIG. 2 is optical microscope (OM) images of the silver nanowire thin film manufactured on various substrates according to Example 4 of the present application;

FIG. 3A is images of measuring the water contact angles of the respective substrates used in Examples 2 and 3 of the present application, and FIG. 3B is optical microscope (OM) images of the silver nanowire thin films manufactured according to Examples 2 and 3;

FIG. 4 is results of measuring the sheet resistance values of the silver nanowire thin films manufactured according to Examples 2 and 3 of the present application;

FIG. 5 is optical microscope (OM) images of the silver nanowire thin films manufactured through Example 5 and Comparative Example 1 of the present application;

FIG. 6 is UV-vis spectra of the silver nanowire thin films manufactured through Example 5 and Comparative Example 1 of the present application;

FIG. 7 is results of measuring the haze values at a wavelength of 550 nm of the silver nanowire electrodes prepared through Example 5 and Comparative Example 1 of the present application;

FIG. 8 is results of measuring the sheet resistance values of the silver nanowire thin films manufactured through Example 5 and Comparative Example 1 of the present application; and

FIG. 9 is optical microscope (OM) images of the silver nanowire thin films manufactured using various added solvents according to Example 6 of the present application.

### DETAILED DESCRIPTION OF THE EMBODIMENT

Hereinafter, embodiments of the present application will be described in detail with reference to the accompanying drawings so that those with ordinary skill in the art to which the present application pertains will easily be able to implement the present application.

However, the present application may be implemented in various different forms and is not limited to the embodiments described herein. Further, parts irrelevant to the description are omitted in order to clearly describe the present application in the drawings, and similar reference numerals are attached to similar parts throughout the specification.

In the whole specification of the present application, when a part is said to be “connected” with the other part, it not only includes a case that the part is “directly connected” to the other part, but also includes a case that the part is “electrically connected” to the other part with another element being interposed therebetween.

In the whole specification of the present application, when any member is positioned “on”, “over”, “above”, “beneath”, “under”, and “below” the other member, this not only includes a case that any member is brought into contact with the other member, but also includes a case that another member exists between two members.

In the whole specification of the present application, if a prescribed part “includes” a prescribed element, this means that another element can be further included instead of excluding other elements unless any particularly opposite description exists.

When unique manufacture and material allowable errors of numerical values are suggested to mentioned meanings of terms of degrees used in the present specification such as “about”, “substantially”, etc., the terms of degrees are used in the numerical values or as a meaning near the numerical values, and the terms of degrees are used to prevent that an unscrupulous infringer unfairly uses a disclosure content in which exact or absolute numerical values are mentioned to help understanding of the present application. Further, in the whole specification of the present application, “a step to do ˜” or “a step of ˜” does not mean “a step for ˜”.

In the whole specification of the present application, a term of “a combination thereof” included in a Markush type expression, which means a mixture or combination of one or more selected from the group consisting of constituent elements described in the Markush type expression, means including one or more selected from the group consisting of the constituent elements.

In the whole specification of the present application, description of “A and/or B” means “A, B, or A and B”.

Hereinafter, a method for preparing a transparent electrode according to the present application, a method for manufacturing a transparent heating film including the transparent electrode, and a transparent heating film manufactured thereby will be described in detail with reference to embodiments, examples, and drawings. However, the present application is not limited to such embodiments, examples, and drawings.

As a technical means for achieving the above-described technical tasks, the first aspect of the present application relates to a method for preparing a transparent electrode, including a step of forming a thin film by coating a solution containing metal nanowires on a substrate, in which the solution containing the metal nanowires contains a mixed solvent in which two or more types of solvents are mixed, and the respective solvents in the mixed solvent have different surface energies and boiling points.

The method for preparing a transparent electrode according to the present application may coat a silver nanowire thin film by forming a collective pattern only by a solution coating process, and may form a more improved patterned electrode by controlling the surface properties of the substrate. Through this, the transparent electrode may have improved optical properties and electrical properties by having improved transmittance, reduced haze, and reduced sheet resistance value compared to the conventional silver nanowire random network electrode.

Specifically, the transparent electrode forms a wavy pattern structure of silver nanowires so that a lot of empty spaces are included compared to conventional silver nanowire electrodes to have high light transmittance and low haze, it has a low sheet resistance compared to the conventional silver nanowire random network electrode so that it may have comprehensively very excellent transparent electrode properties, and these excellent transparent electrode properties may have high utilization in transparent electrodes and the like of transparent planar heating elements, smart windows, and large-area touch panels in the future. Further, the wavy pattern structure may easily disperse mechanical stress to more stably maintain electrical properties against various mechanical deformations such as bending, twisting, tension, etc. so that it may be applied to various foldable, rollable, stretchable, and wearable devices.

Further, unlike the conventional transparent heating film in which the thermal stability of silver nanowires was low, and there has been a problem in that the electrode properties could not be maintained due to the occurrence of breakage phenomenon at high temperatures, the transparent heating film manufactured by the manufacturing method according to the present application includes a transparent electrode in which silver nanowires form a wave pattern, and the wave pattern is formed in the form of a bundled mesh that is thicker than general silver nanowires so that it has excellent thermal stability to enable the electrode properties to be maintained even at high temperatures.

Further, since the method for preparing a transparent electrode according to the present application induces self-pattern formation of silver nanowires through control of the evaporation of a solvent after solution coating so that additional processes such as exposure, etching, and the like, which have been used in conventional silver nanowire patterning, are not used, the process steps may be drastically reduced. Accordingly, since there is no silver nanowire discarded in the etching process after coating, it may be economical.

In the step of forming the thin film, variables such as Marangoni flow, capillary flow, and the like, which occur when solvents having different surface energies are mixed, and variables such as interaction with the substrate are present, and the respective variables may act complexly to obtain a result that individual silver nanowires are condensed in the form of a wave (nanomesh) pattern when forming a thin film.

At this time, since each variable is changed by the difference in surface energy, the transparent electrode may be prepared to have various types of nanomesh patterns by mixing the solvents in consideration of the surface energy between solvents to be mixed.

According to an embodiment of the present application, the mixed solvent may include a first solvent and a second solvent, and the first solvent and the second solvent may be mixed at a ratio of 1:1 to 1:3, but the present application is not limited thereto.

Preferably, the first solvent and the second solvent may have a ratio of 1:2, but the present application is not limited thereto.

According to an embodiment of the present application, the first solvent may be water (deionized water), and the second solvent may be one selected from the group consisting of isopropyl alcohol, ethanol, propanol, acetic anhydride, cyclopentanone, diethylhydroxylamine, ethyl acetate, dichloromethane, tert-butyl alcohol, tert-butyl amine, acetonitrile, pyrrolidine, and combinations thereof, but the present application is not limited thereto.

The mixed solvent may be formed by further mixing a solvent having a surface energy different from those of the first solvent and the second solvent in addition to including the first solvent and the second solvent.

According to an embodiment of the present application, the step of forming a thin film by coating a solution containing metal nanowires on the substrate may be performed by a method selected from the group consisting of bar coating, slot die coating, blade coating, and combinations thereof, but the present application is not limited thereto.

The conventional method of coating a solution containing metal nanowires was mainly performed by spray coating. However, when coating is carried out by spray coating in the method according to the present application, the solvent is individually sprayed in the form of small water droplets and drying proceeds while the solvent is being coated on the substrate. Due to this, there is a problem in that the entire thin film is not connected in a single mesh form, and another ring is coated in a misaligned and added form on the ring-shaped silver nanowire bundle, thereby deteriorating overall properties. Therefore, in the method for preparing a transparent electrode according to the present application, it is appropriate to use bar coating, blade coating, slot die coating, etc., which are coating methods that can simultaneously form thin films at once in order not to cause the above-mentioned problem, and that enable mass-production.

According to an embodiment of the present application, the metal nanowires may have a wave pattern shape and form a network on the transparent electrode, but the present application is not limited thereto.

The metal nanowires have a wave pattern shape and form a network so that the transparent electrode includes a lot of empty spaces compared to conventional metal nanowire electrodes to have high light transmittance and low haze, and the transparent electrode has a low sheet resistance compared to the conventional metal nanowire random network electrode so that it may have comprehensively very excellent transparent electrode properties, and these excellent transparent electrode properties may have high utilization in transparent electrodes and the like of transparent planar heating elements, smart windows, and large-area touch panels in the future. Further, the wavy pattern structure may easily disperse mechanical stress to more stably maintain electrical properties against various mechanical deformations such as bending, twisting, tension, etc. so that it may be applied to various foldable, rollable, stretchable, and wearable devices.

According to an embodiment of the present application, the metal nanowires may include a metal selected from the group consisting of Ag, Au, Pt, Ti, Pd, Fe, Cu, Co, Ni, Al, and combinations thereof, but the present application is not limited thereto.

According to an embodiment of the present application, the substrate may include a substrate selected from the group consisting of polyimide (PI), polyethylene naphthalate (PEN), polyethylene terephthalate (PET), glass, Si wafer, and combinations thereof, but the present application is not limited thereto.

Further, the second aspect of the present application relates to a method for manufacturing a transparent heating film, including the steps of: preparing a transparent electrode according to the first aspect of the present application; and transferring the transparent electrode onto a first transparent substrate.

With respect to the method for manufacturing a transparent heating film according to the second aspect of the present application, detailed descriptions of parts overlapping with the first aspect of the present application have been omitted, but even if the descriptions have been omitted, the contents described in the first aspect of the present application may be equally applied to the second aspect of the present application.

The method for manufacturing a transparent heating film according to the present application may manufacture the transparent heating film through the process of first preparing a transparent electrode by the method according to the first aspect of the present application, and then transferring the transparent electrode onto a transparent substrate.

Pressed glass for automobiles is formed in the form of glass/polyvinyl butyral (PVB)/glass, and PVB with bumpy shape having a large surface roughness is used in order to prevent air bubbles that may occur between glass and PVB when thermocompressing PVB between glass and glass. For this reason, when a solution containing metal nanowires is coated on PVB, the solution is concentrated in the recessed part, which causes a problem that the coating cannot be performed evenly over the entire surface.

Further, PVB is soluble in solvents such as isopropyl alcohol (IPA), ethanol, toluene, etc. Since the solvent used for preparing the transparent electrode also uses IPA, etc., when a solution containing metal nanowires is coated on PVB, the solution may not only dissolve the PVB surface to break the structure, but also allow PVB to penetrate between the metal nanowire networks so that a result of decreasing conductivity may occur.

Therefore, the transparent heating film may be manufactured without the above problems through the process of preparing the transparent electrode on the transfer substrate and then transferring the prepared transparent electrode onto the transparent substrate.

According to an embodiment of the present application, the step of transferring the transparent electrode onto the first transparent substrate may be performed by a method selected from the group consisting of lamination, thermocompression bonding, mechanical transfer, wet transfer, and combinations thereof, but the present application is not limited thereto.

According to an embodiment of the present application, the method may further include a step of disposing a second transparent substrate on the transferred transparent electrode, but the present application is not limited thereto.

According to an embodiment of the present application, the first transparent substrate and the second transparent substrate may include one selected from the group consisting of polyvinyl butyral (PVB), glass, ITO, FTO, polyphthalate carbonate (PPC), poly(methyl methacrylate) (PMMA), polyurethane (PU), poly(cyclohexylene dimethylene) terephthalate (PCT), and combinations thereof, but the present application is not limited thereto.

Further, the third aspect of the present application provides a transparent heating film including a first transparent substrate and a second transparent substrate, and including a transparent electrode disposed between the first transparent substrate and the second transparent substrate, in which the transparent electrode is prepared according to the first aspect of the present application.

With respect to the transparent heating film according to the third aspect of the present application, detailed descriptions of parts overlapping with the first aspect of the present application and/or the second aspect of the present application have been omitted, but even if the descriptions have been omitted, the contents described in the first aspect of the present application and/or the second aspect of the present application may equally be applied to the third aspect of the present application.

According to an embodiment of the present application, the transparent electrode may have an electrode formed thereon, but the present application is not limited thereto.

The transparent heating film according to the present application is an object that generates heat while being transparent due to high transmittance to visible light. Specifically, when power is applied to the electrode formed on the transparent heating film, resistance heat is generated by resistance so that heat may be uniformly generated in a predetermined area of the transparent heating film. Accordingly, the transparent heating film may be applied to transparent heating glass or the like.

Further, unlike the conventional transparent heating film in which the thermal stability of silver nanowires was low, and there has been a problem in that the electrode properties could not be maintained due to the occurrence of breakage phenomenon at high temperatures, the transparent heating film manufactured by the manufacturing method according to the present application includes a transparent electrode in which silver nanowires form a wave pattern, and the wave pattern is formed in the form of a bundled mesh that is thicker than general silver nanowires so that it has excellent thermal stability to enable the electrode properties to be maintained even at high temperatures.

According to an embodiment of the present application, the transparent electrode may have a sheet resistance of 0.1 to 20Ω/□, but the present application is not limited thereto.

Hereinafter, the present disclosure will be described in more detail through Examples, but the following Examples are for explanation purposes only and are not intended to limit the scope of the present application.

### Example 1

Deionized water (D.I. water) was added to a solution of isopropyl alcohol (IPA) in which 0.5% by weight of silver nanowires were dispersed at a certain volume ratio compared to IPA (1 to 300 vol % compared to IPA) to prepare a solution containing the silver nanowires.

The solution was bar-coated on a polyimide substrate at a lower temperature condition of 120° C. to form a silver nanowire thin film.

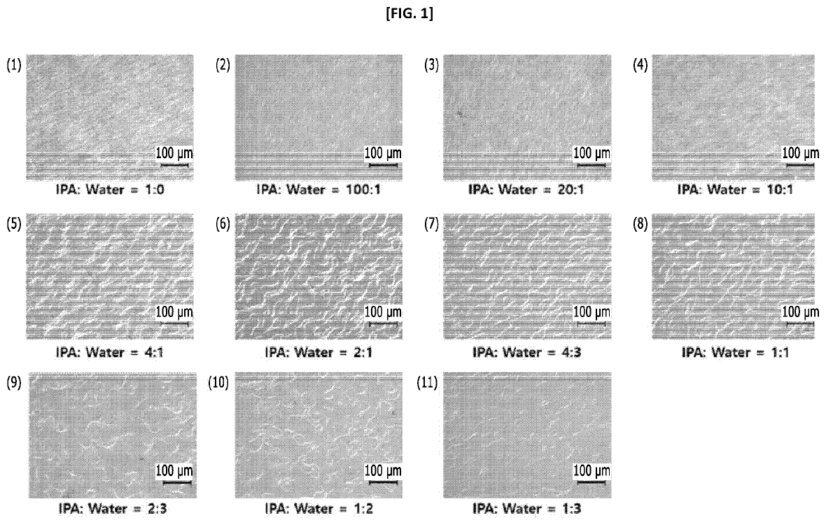

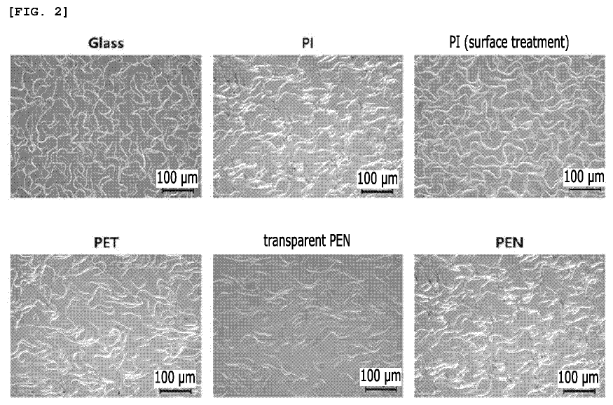

FIG. 1 shows optical microscope (OM) images of the silver nanowire thin film manufactured with a solution containing silver nanowires containing solvents having various mixing ratios according to Example 1 of the present application.

Referring to FIG. 1, it can be confirmed that when IPA and D.I. water have a ratio of 2:1, the clearest wave pattern is formed.

### Example 2

A solution (a silver nanowire content of about 0.33% by weight) containing silver nanowires dispersed in a solvent in which isopropyl alcohol and deionized water were mixed at a ratio of 2:1 was prepared.

The solution was bar-coated on a polyimide substrate at a lower temperature condition of 120° C. to form a silver nanowire thin film.

### Example 3

A solution (a silver nanowire content of about 0.33% by weight) containing silver nanowires dispersed in a solvent in which isopropyl alcohol and deionized water were mixed at a ratio of 2:1 was prepared.

The solution was bar-coated on a polyimide substrate treated with UV/ozone for 10 minutes at a lower temperature condition of 120° C. to form a silver nanowire thin film.

### Example 4

A solution (a silver nanowire content of about 0.33% by weight) containing silver nanowires dispersed in a solvent in which isopropyl alcohol and deionized water were mixed at a ratio of 2:1 was prepared.

The solution was bar-coated on various substrates (polyimide, polyethylene terephthalate, polyethylene naphthalate, glass, etc.) at a lower temperature condition of 120° C. to form a silver nanowire thin film.

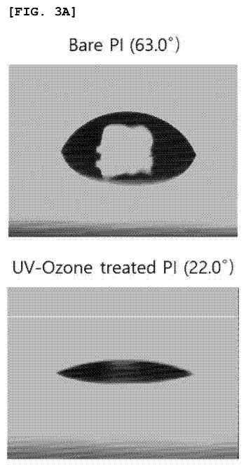

FIG. 2 is optical microscope (OM) images of the silver nanowire thin film manufactured on various substrates according to Example 4 of the present application.

### Example 5

A solution (a silver nanowire content of about 0.33% by weight) containing silver nanowires dispersed in a solvent in which isopropyl alcohol and deionized water were mixed at a ratio of 2:1 was prepared.

The solution was bar-coated on a glass substrate at a lower temperature condition of 140° C. to form a silver nanowire thin film.

### Example 6

A solution (a silver nanowire content of about 0.33% by weight) containing silver nanowires dispersed in a solvent in which isopropyl alcohol and various added solvents (acetic anhydride, cyclopentanone, diethylhydroxylamine, ethyl acetate, dichloromethane, tert-butyl alcohol, acetonitrile, etc.) were mixed at a ratio of 2:1 was prepared.

The solution was bar-coated on a polyimide substrate at a lower temperature condition of 100° C. to form a silver nanowire electrode.

### Comparative Example 1

A solution (a silver nanowire content of about 0.33% by weight) containing silver nanowires dispersed in an isopropyl alcohol solvent was prepared.

The solution was bar-coated on a glass substrate at a lower temperature condition of 140° C. to form a silver nanowire electrode.

### [Experimental Example 1] Comparison of Examples 2 and 3

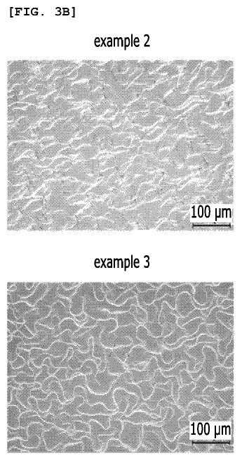

FIG. 3A is images of measuring the water contact angles of the respective substrates used in Examples 2 and 3 of the present application, and FIG. 3B is optical microscope (OM) images of the silver nanowire thin films manufactured according to Examples 2 and 3.

Referring to FIG. 3A, it could be confirmed that the contact angle was reduced by about 41° in the case of a UV/ozone-treated polyimide (UV/Ozone-treated PI) substrate having a water contact angle of 22° compared to the bare polyimide (PI) on which had not been treated with UV/ozone.

Referring to FIG. 3B, the formation of a more distinct silver nanowire pattern could be confirmed in the silver nanowire thin film of Example 3 using the UV/Ozone-treated polyimide substrate.

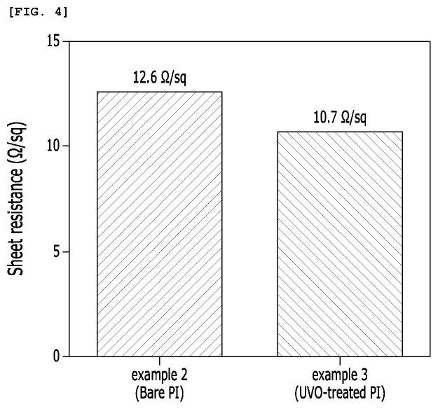

FIG. 4 is results of measuring the sheet resistance values of the silver nanowire thin films manufactured according to Examples 2 and 3 of the present application.

Referring to FIG. 4, it can be confirmed that the silver nanowire thin film of Example 3 using the UV/Ozone-treated polyimide substrate has a sheet resistance of about 10.7Ω/sq which is about 1.9Ω/sq lower than that of the silver nanowire thin film of Example 2.

### [Experimental Example 2] Comparison of Example 5 and Comparative Example 1

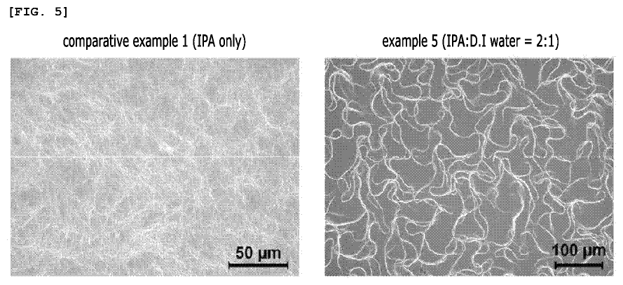

FIG. 5 is optical microscope (OM) images of the silver nanowire thin films manufactured through Example 5 and Comparative Example 1 of the present application.

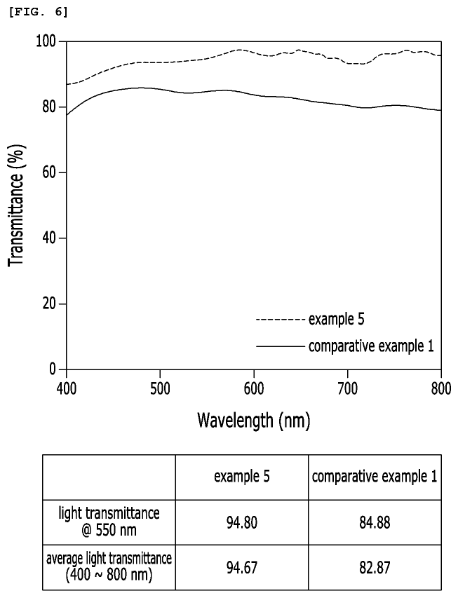

FIG. 6 is UV-vis spectra of the silver nanowire thin films manufactured through Example 5 and Comparative Example 1 of the present application.

Referring to FIG. 6, it can be confirmed that the light transmittance of the silver nanowire thin film formed through Example 5 is improved by about 14% compared to Comparative Example 1.

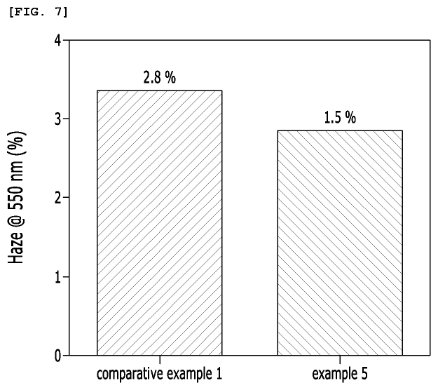

FIG. 7 is results of measuring the haze values at a wavelength of 550 nm of the silver nanowire electrodes prepared through Example 5 and Comparative Example 1 of the present application.

Referring to FIG. 7, it can be confirmed that the haze of the patterned electrode formed through Example 5 is reduced by about 45% compared to Comparative Example 1.

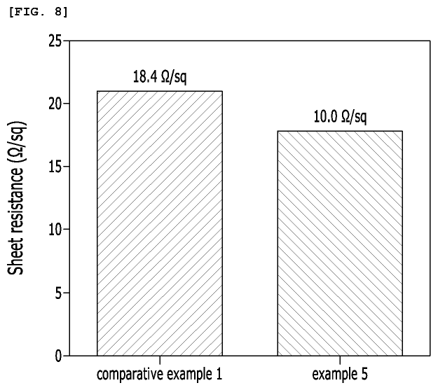

FIG. 8 is results of measuring the sheet resistance values of the silver nanowire thin films manufactured through Example 5 and Comparative Example 1 of the present application.

Referring to FIG. 8, it can be confirmed that the sheet resistance of the patterned electrode formed through Example 5 is reduced by about 45% compared to Comparative Example 1.

It could be confirmed through Experimental Example 2 that the thin film manufactured by the method of the present application had improved optical properties.

### Experimental Example 3

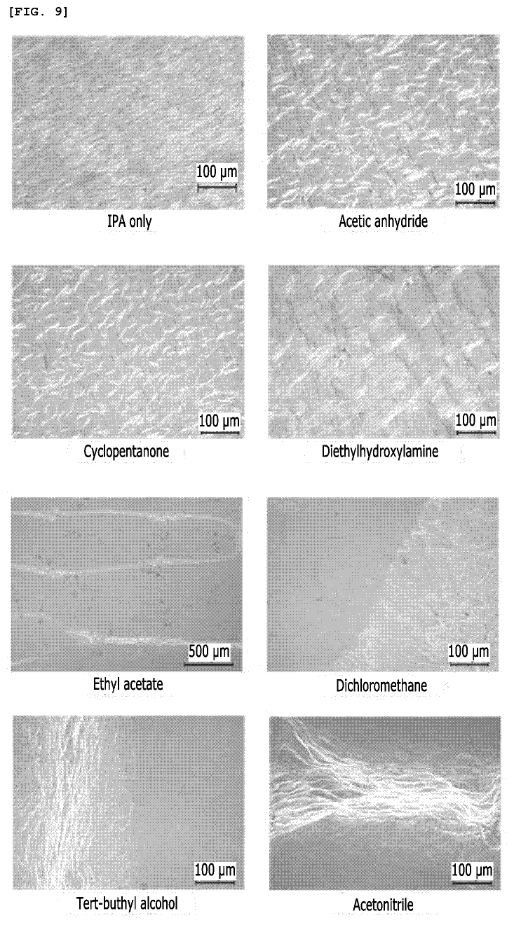

FIG. 9 is optical microscope (OM) images of the silver nanowire thin films manufactured using various added solvents according to Example 6 of the present application.

Referring to FIG. 9, it can be confirmed that silver nanowire thin films having various patterns are formed by mixing isopropyl alcohol (IPA) with various added solvents such as acetic anhydride, cyclopentanone, diethylhydroxylamine, ethyl acetate, dichloromethane, tert-butyl alcohol, acetonitrile, and the like in addition to deionized water (D.I. Water).

The foregoing description of the present application is for illustration, and those with ordinary skill in the art to which the present application pertains will be able to understand that it can be easily modified into other specific forms without changing the technical spirit or essential features of the present application. Therefore, it should be understood that the embodiments described above are illustrative in all respects and not restrictive. For example, each element described as a single form may be implemented in a dispersed form, and likewise, elements described in the dispersed form may also be implemented in a combined form.

The scope of the present application is indicated by the claims to be described later rather than the above-detailed description, and all changes or modified forms derived from the meaning and scope of the claims and equivalent concepts thereof should be construed as being included in the scope of the present application.

1. A method for preparing a transparent electrode, the method comprising a step of forming a thin film by coating a solution containing metal nanowires on a substrate, wherein the solution containing the metal nanowires contains a mixed solvent in which two or more types of solvents are mixed, and the respective solvents in the mixed solvent have different surface energies and boiling points.

2. The method of claim 1, wherein the step of forming a thin film by coating a solution containing metal nanowires on a substrate is performed by a method selected from the group consisting of bar coating, slot die coating, blade coating, and combinations thereof.

3. The method of claim 1, wherein the mixed solvent includes a first solvent and a second solvent, and the first solvent and the second solvent are mixed at a ratio of 1:1 to 1:3.

4. The method of claim 3, wherein the first solvent is water (deionized water), and the second solvent is one selected from the group consisting of isopropyl alcohol, ethanol, propanol, acetic anhydride, cyclopentanone, diethylhydroxylamine, ethyl acetate, dichloromethane, tert-butyl alcohol, tert-butyl amine, acetonitrile, pyrrolidine, and combinations thereof.

5. The method of claim 1, wherein the metal nanowires have a wave pattern shape and form a network on the transparent electrode.

6. The method of claim 1, wherein the metal nanowires include a metal selected from the group consisting of Ag, Au, Pt, Ti, Pd, Fe, Cu, Co, Ni, Al, and combinations thereof.

7. The method of claim 1, wherein the substrate includes a substrate selected from the group consisting of polyimide (PI), polyethylene naphthalate (PEN), polyethylene terephthalate (PET), glass, Si wafer, and combinations thereof.

8. A method for manufacturing a transparent heating film, the method comprising steps of:
preparing a transparent electrode according to claim 1; and
transferring the transparent electrode onto a first transparent substrate.

9. The method of claim 8, further comprising a step of disposing a second transparent substrate on the transferred transparent electrode.

10. The method of claim 8, wherein the step of transferring the transparent electrode onto the first transparent substrate is performed by a method selected from the group consisting of lamination, thermocompression bonding, mechanical transfer, wet transfer, and combinations thereof.

11. The method of claim 9, wherein the first transparent substrate and the second transparent substrate include one selected from the group consisting of polyvinyl butyral (PVB), glass, ITO, FTO, polyphthalate carbonate (PPC), poly(methyl methacrylate) (PMMA), polyurethane (PU), poly(cyclohexylene dimethylene) terephthalate (PCT), and combinations thereof.

12. A transparent heating film including a first transparent substrate and a second transparent substrate, and including a transparent electrode disposed between the first transparent substrate and the second transparent substrate, wherein the transparent electrode is prepared according to claim 1.

13. The transparent heating film of claim 12, wherein the transparent electrode has an electrode formed thereon.

14. The transparent heating film of claim 12, wherein the transparent electrode has a sheet resistance of 0.1 to 20Ω/□.
